(19) United States
(12) Patent Application Publication
(10) Pub. No.: US 2009/0210873 A1
(43) Pub. Date: Aug. 20, 2009

(54) RE-TASKING A MANAGED VIRTUAL MACHINE IMAGE IN A VIRTUALIZATION DATA PROCESSING SYSTEM

(75) Inventors: Gennaro A. Cuomo, Durham, NC (US); Matt R. Hogstrom, Cary, NC (US); Sai G. Rathnam, Raleigh, NC (US); Matthew J. Sheard, Morrisville, NC (US); Brian L. White Eagle, Austin, TX (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/032,351

(22) Filed: Feb. 15, 2008

(51) Int. Cl. G06F 9/455

(52) U.S. Cl. 718/1

(57) ABSTRACT

Embodiments of the present invention provide a method, system and computer program product for virtualization of application lifecycles. In an embodiment of the invention, a virtualization data processing system can be provided. The system can include a hypervisor configured for execution in a host computing platform, a VM image managed by the hypervisor, and a configuration applied to the VM image. The configuration can specify a set of resources in the host computing platform accessible by applications executing in the VM image. Finally, the system can include re-tasking logic coupled to the hypervisor. The logic can include program code enabled to select a new role for the VM image, to determine a new configuration for the new role, and to apply the new configuration to the VM image.

### BACKGROUND OF THE INVENTION

1. Field of the Invention

The present invention relates to the field of virtualization and more particularly to hypervisor management of virtualized computing environments.

2. Description of the Related Art

For many decades, computing implied both an application and a supporting platform. Until the late twentieth century, a host computing environment included a hardware infrastructure of processor core, input/output, memory and fixed storage, the combination of which supported an operating system, which in turn supported the execution of a single application at a time. Gradually, as processor power increased exponentially, advanced forms of the operating system enabled both simulated and actual multi-tasking such that multiple applications could execute within the same host computing environment.

Initially, applications were self contained bundles of logic relying on little other than core object files and related resource files. As computing become integral to modern industry, however, applications became co-dependent on the presence of other applications such that the requisite environment for an application included not only the underlying operating system and supporting hardware platform, but also other key applications including application servers, database management servers, collaboration servers and communicative logic commonly referred to as middleware. Given the complexity of application and platform interoperability, however, different combinations of applications executing in a single hardware platform can demonstrate differing degrees of performance and stability.

Virtualization as a technology aims to interject a layer between the hardware platform and operating system and executing applications. From the perspective of business continuity and disaster recovery, virtualization provides the inherent advantage of environment portability. Specifically, to move an entire environment configured with multiple different applications is a matter of moving a virtual image from one supporting hardware platform to another. Further, more powerful computing environments can support the coexistence of multiple different virtual images, all the while maintaining a virtual separation between the images. Consequently, a failure condition in one virtual image cannot jeopardize the integrity of other co-executing virtual images in the same hardware platform.

A virtual machine monitor, known in the art as a “hypervisor”, manages the interaction between each virtual image and the underlying resources provided by the hardware platform. In this regard, a bare metal hypervisor runs directly on the hardware platform much as an operating system runs directly on hardware. By comparison, a hosted hypervisor runs within a host operating system. In either case, the hypervisor can support the operation of different “guest operating system images”—known as virtual machine (VM) images—the number of VM images being limited only by the processing resources of a VM container holding the VM images or the hardware platform itself.

Virtualization has proven especially useful for those end users requiring separate computing environments for different types of applications while being limited to a single hardware platform. For instance, it is well known for a primary operating system native to one type of hardware platform to provide a virtualized guest operating system native to a different hardware platform so that applications requiring the presence of the guest operating system can co-exist with other applications requiring the presence of the primary operating system. In this way, the end user need not provide separate computing environments each to support a different type of application. Yet, no matter the guest operating system, access to underlying resources of the single hardware platform remains static.

### BRIEF SUMMARY OF THE INVENTION

Embodiments of the present invention address deficiencies of the art in respect to virtualization and provide a novel and non-obvious method, system and computer program product for virtualization of application lifecycles. In an embodiment of the invention, a virtualization data processing system can be provided. The system can include a hypervisor configured for execution in a host computing platform, a VM image managed by the hypervisor, and a configuration applied to the VM image. The configuration can specify a set of resources in the host computing platform accessible by applications executing in the VM image. Finally, the system can include re-tasking logic coupled to the hypervisor. The logic can include program code enabled to select a new role for the VM image, to determine a new configuration for the new role, and to apply the new configuration to the VM image. In this way, access to the resources of the host computing platform is not static, but can vary to meet the different objectives of different roles for different computing environments provided by different VM images managed by the hypervisor.

In one aspect of the embodiment, the hypervisor can be configured for execution in a VM container such as a logical partition (LPAR) in the host computing platform. In another aspect of the embodiment, the system further can include a monitor monitoring performance for other VM images managed by the hypervisor and detecting a need for the new role based upon the performance. In yet another aspect of the embodiment, the configuration can specify a requisite operating system, an amount and type of physical memory, and fixed storage. Further, the configuration can specify requisite communications access. Even yet further, the configuration can specify pre-requisite co-executing applications in the VM image.

In another embodiment of the invention, a method for re-tasking a managed VM image can be provided in a virtualization data processing system. The method can include configuring a VM image image in a hypervisor to provide a computing environment for applications hosted in the VM image in accordance with a selected role for the VM image. The method also can include determining a role change to a new role for the VM image. Yet further, the method can include selecting a different configuration for the new role to provide a different computing environment for the applications hosted in the VM image. Finally, the method can include applying the different configuration to the VM image to provide the different computing environment.

In consequence, different computing environments can be established for different roles to be fulfilled by the VM images without requiring an end user to support different host computing platforms for each role. In this regard, the computing environment provided by VM image for the selected role can include a test environment, and the different computing environment provided by VM image for the new role can include a production environment. Likewise, the computing environment provided by VM image for the selected role can include a test environment, and the different computing environment provided by VM image for the new role can include a quality assurance environment.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a virtualization data processing system configured to re-task managed VM images;

FIG. 2 is a schematic illustration of an virtual machine container implementation of a virtualization data processing system configured to re-task managed VM images;

FIG. 3 is a flow chart illustrating a process for re-tasking a managed VM image in a virtualization data processing system; and,

FIG. 4 is a schematic illustration of a virtual machine container implementation of a virtualization data processing system configured to re-task managed VM images for clustered application instances.

### DETAILED DESCRIPTION OF THE INVENTION

Embodiments of the present invention provide a method, system and computer program product for re-tasking a managed VM image in a virtualization data processing system. In accordance with an embodiment of the present invention, a VM image can be created within a virtualization data processing system. A role can be selected for the VM image and a configuration corresponding to the selected role can be applied to the VM image. In this regard, the configuration can include a set of resources in an underlying computing platform to be accessed by the VM image. Thereafter, the role for the VM image can change. In response, a different configuration corresponding to the new role can be applied to the VM image. In access to and use of the resources of the underlying computing platform can be balanced between the roles fulfilled by different VM images managed in the virtualization data processing system.

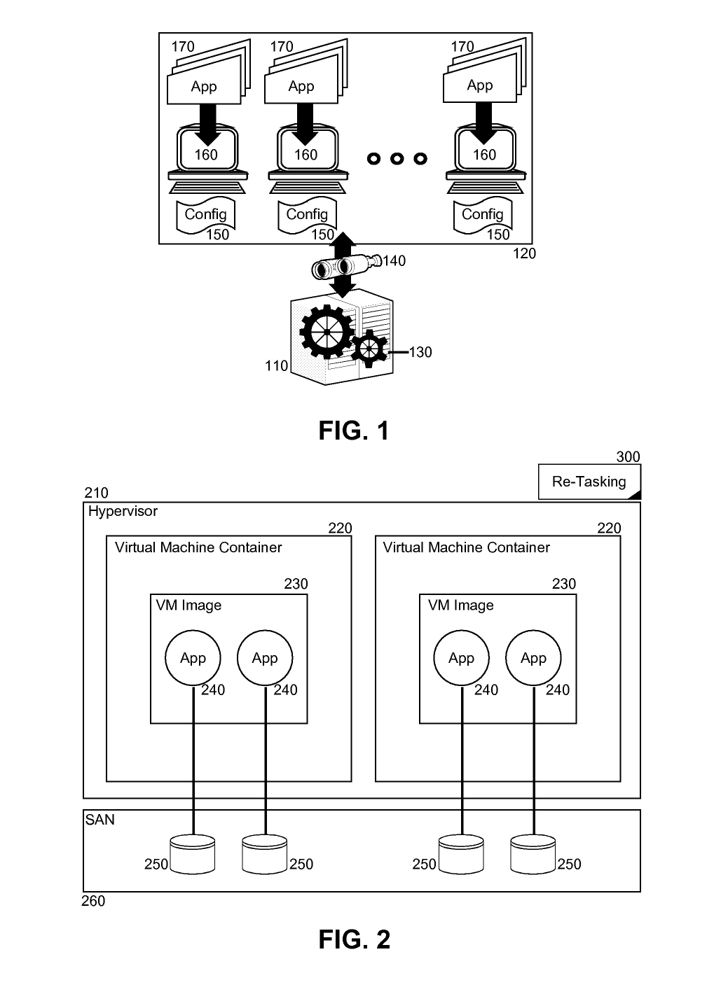

In further illustration, FIG. 1 is a pictorial illustration of a virtualization data processing system configured to re-task managed VM images. As shown in FIG. 1, a host computing platform 110 can support the operation of a hypervisor 120 managing multiple different VM images 160. Each of the VM images 160 can provide a computing environment for one or more corresponding applications 170. As such, the hypervisor 120 can establish a configuration 150 for each different one of the VM images 160 specifying requisite access to different computing resources 130 provided by the host computing platform 110, for instance processor, memory, file system, communications and even other ones of the VM images 160. The requisite access specified in each configuration 150 can support the intended role of the computing environment provided by each of the VM images 160.

Notably, a monitor 140 can monitor the performance and operation of each of the VM images 160. Consequently, the monitor 140 can determine when a change in role is expected for a given one of the VM images 160. A change in role, of course, can result in a change in requisite access to the computing resources 130 provided by the host computing platform 110. In response, the hypervisor 120 can specify a different configuration 150 for affected ones of the VM images 160 in order to accommodate the change in role. In this way, the VM images 160 can be re-tasked dynamically to address changing environmental needs provided within a virtualized platform.

The process described in FIG. 1 can be embodied within a VM container oriented computing platform such as a mainframe computing platform, a midrange or minicomputer computing platform, or even high-performance server computing platforms. In illustration, FIG. 2 schematically shows a VM container implementation of a virtualization data processing system configured to re-task managed VM images. The system can include a hypervisor 210 communicatively coupled to a storage area network 260 of different fixed storage units 250. The hypervisor 210 can create and manage different VM images 230, each separately disposed in a different VM containers 220, for instance logical partitions (LPARs).

Each VM image 230 can support the operation of one or more executing application instances 240 such that from the perspective of the executing application instances 240, virtualization provided by the hypervisor 210 is transparent. The application instances 240 further can access computing resources like the storage units 250 as specified by a configuration for each VM image 230 through a corresponding VM container 220. The nature and depth of access to the computing resources, however, can vary according to a role fulfilled by the VM image 230 in providing a computing environment for the application instances 240. In this regard, in a production environment, performance can be of paramount importance, while in a test environment, performance is not as important as isolation to promote stability of other applications. Thus, in the former circumstance, access to extensive resources about the host computing platform can be provided, while in the latter circumstance, limited access to resources isolated from other resources about the host computing platform can be provided.

Notably, re-tasking logic 300 can be coupled to the hypervisor 210. The re-tasking logic 300 can include program code enabled to identify a change in role for a computing environment provided by a VM image 230. The program code further can be enabled to respond to the identified change in role by determining a different set of resources requisite to the change in role. The program code yet further can be enabled to change a configuration for the VM image 230 in order to implement access to the different set of resources requisite to the change in role. In this way, one need not deploy a separate computing platform to provide a required computing environment corresponding to each potential role to be fulfilled in the course of an application lifecycle.

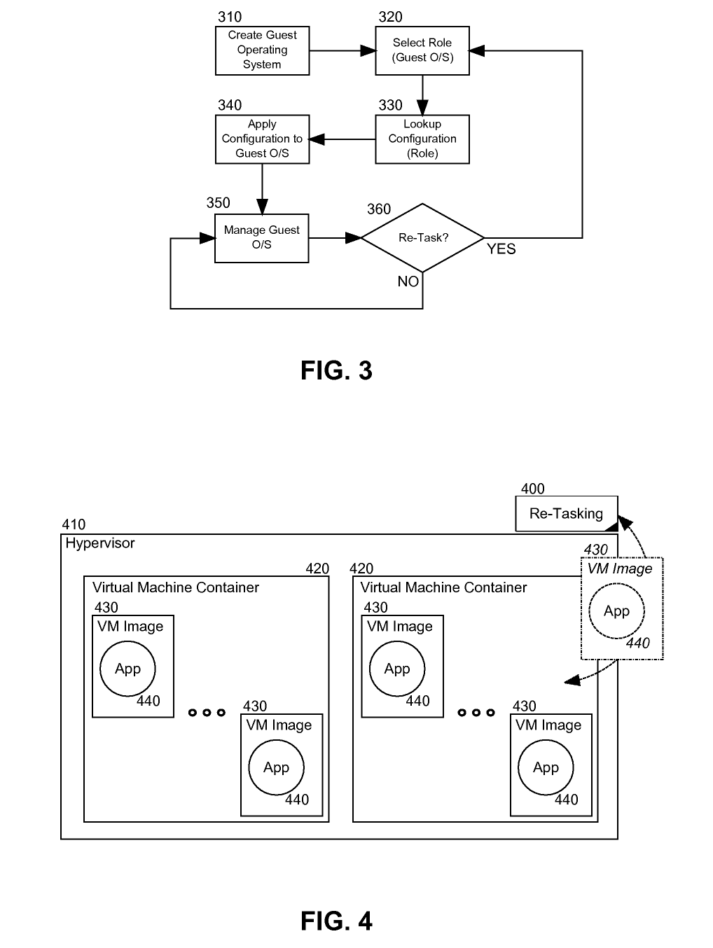

In yet further illustration, FIG. 3 is a flow chart illustrating a process for re-tasking a managed VM image in a virtualization data processing system. Beginning in block 310, a VM image can be created and in block 320, a role can be selected to be fulfilled by a computing environment provided by the VM image. In block 330, a configuration can be determined for the selected role. For instance, the configuration can specify a requisite operating system, amount and type of physical memory and fixed storage, communications bandwidth and access, and even pre-requisite co-executing applications including middleware functionality. Thereafter, the configuration can be applied to the VM image in block 340 and the VM image can be enabled for management and in fact managed in block 350 to provide the desired computing environment.

In decision block 360, it can be determined whether or not to re-task the VM image with a different role. This determination can be resolved manually by user specification of a different role (for example, changing a computing environment from a production mode to a testing mode, or from a production mode to a quality assurance mode, or from a general computing mode to a safe computing mode, etc.). Alternatively, this determination can be resolved automatically by monitoring the performance of different VM images, identifying a particular one of the VM images failing to provide the desired computing environment due to a failure to provide a level of access to requisite resources due to the use of those resources by other VM images. In consequence, a re-tasking of the VM images can enable the particular one of the VM images to provide the desired computing environment.

When a re-tasking of a VM image image is determined, the process can return to block 320 with a selection of a new role for the VM image, the location of a configuration supporting the new role, the application of the located configuration to the VM image and continuation of the process through block 350 with the deployment and management of the VM image in its new role. The overall process can continue indefinitely so long as the underlying hypervisor permits the existence of the VM image.

In an optional aspect, the new role can implicate a higher degree or lower degree of availability for an application deployed into a VM image in a cluster of application instance. In illustration, FIG. 4 schematic schematically shows a virtual machine container implementation of a virtualization data processing system configured to re-task managed VM images for clustered application instances. As shown in FIG. 4, a hypervisor 410 can provide different VM containers 420, each of which can include one or more VM images 430.

Each VM image 430 can include an application instance 440 configured to service requests such that an arrangement of VM images 430 in the VM container 420 can provide a clustered environment for the application instance 440 to support high availability of the application instance 440. Consequently, the high-availability environment provided by the VM container 420 can be modified dynamically by the program code of the re-tasking logic 400 by adding or removing new VM images 430 with corresponding application instances 440 to and from a virtual machine container 320 in order to change the availability characteristics of the cluster.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A virtualization data processing system comprising:
a hypervisor configured for execution in a host computing platform;
a virtual machine (VM) image managed by the hypervisor;
a configuration applied to the VM image, the configuration specifying a set of resources in the host computing platform accessible by applications executing in the VM image; and,
re-tasking logic coupled to the hypervisor, the logic comprising program code enabled to select a new role for the VM image, to determine a new configuration for the new role, and to apply the new configuration to the VM image.

2. The system of claim 1, wherein the VM image is managed in a VM container.

3. The system of claim 2, wherein the VM container is a logical partition (LPAR) in the host computing platform.

4. The system of claim 1, further comprising a monitor monitoring performance for other VM images managed by the hypervisor and detecting a need for the new role based upon the performance.

5. The system of claim 1, wherein the configuration specifies a requisite operating system, an amount and type of physical memory, and fixed storage.

6. The system of claim 4, wherein the configuration further specifies requisite communications access.

7. The system of claim 4, wherein the configuration further specifies pre-requisite co-executing applications in the VM image.

8. The system of claim 2, wherein the program code of the re-tasking logic is further enabled to select a new degree of availability for the VM container, to determine a new configuration of a requisite number of application instances in corresponding VM images to be present in the VM container, and to apply the new configuration to the VM image.

9. A method for re-tasking a managed VM image in a virtualization data processing system, the method comprising:
configuring a VM image image in a hypervisor to provide a computing environment for applications hosted in the VM image in accordance with a selected role for the VM image;
determining a role change to a new role for the VM image;
selecting a different configuration for the new role to provide a different computing environment for the applications hosted in the VM image; and,
applying the different configuration to the VM image to provide the different computing environment.

10. The method of claim 9, wherein the computing environment provided by VM image for the selected role is a test environment, and wherein the different computing environment provided by VM image for the new role is a production environment.

11. The method of claim 9, wherein the computing environment provided by VM image for the selected role is a test environment, and wherein the different computing environment provided by VM image for the new role is a quality assurance environment.

12. A computer program product comprising a computer usable medium embodying computer usable program code for re-tasking a managed VM image in a virtualization data processing system, the computer program product comprising:
computer usable program code for configuring a VM image image in a hypervisor to provide a computing environment for applications hosted in the VM image in accordance with a selected role for the VM image;
computer usable program code for determining a role change to a new role for the VM image;
computer usable program code for selecting a different configuration for the new role to provide a different computing environment for the applications hosted in the VM image; and,
computer usable program code for applying the different configuration to the VM image to provide the different computing environment.

13. The computer program product of claim 12, wherein the computing environment provided by VM image for the selected role is a test environment, and wherein the different computing environment provided by VM image for the new role is a production environment.

14. The computer program product of claim 12, wherein the computing environment provided by VM image for the selected role is a test environment, and wherein the different computing environment provided by VM image for the new role is a quality assurance environment.
